(19) United States
(12) Patent Application Publication
(10) Pub. No.: US 2025/0110435 A1
(43) Pub. Date: Apr. 3, 2025

(54) DUPLEX PRINTING DEVICE AND IMAGE OFFSET CORRECTION METHOD THEREOF

(71) Applicant: AVISION INC., HSINCHU (TW)

(72) Inventors: Tsang-Sheng CHEN, HSINCHU (TW); Chen-Chang LI, HSINCHU (TW); Shao-Lan SHENG, HSINCHU (TW)

(21) Appl. No.: 18/896,909

(22) Filed: Sep. 26, 2024

(30) Foreign Application Priority Data
Sep. 28, 2023 (TW) 112137446

(51) Int. Cl. G03G 15/23; G03G 15/00

(52) U.S. Cl. CPC G03G 15/234; G03G 15/50; G03G 15/6502; G03G 15/6579

(57) ABSTRACT

A duplex printing device and an image offset correction method thereof are provided. In the duplex printing device, a paper medium is induced to pass through an image processing device by a first path and a second path respectively, and a processor calculates, drives and performs image processing technologies. When the paper medium passes through the first path and the second path, the first side alignment image and the second side deviation image of the paper medium are respectively obtained, and position deviation information is calculated according to the first side alignment image and the second side deviation image, and the light sensing position of the image processing device is adjusted to change a transfer print starting point according to the position deviation information. Thus, during next printing, transfer print information may be located on the center position of the second side of the paper medium with any size.

### CROSS-REFERENCE TO RELATED APPLICATIONS

This application claims the priority benefit of Taiwan Patent Application Serial Number 112137446, filed on Sep. 28, 2023, the full disclosure of which is incorporated herein by reference.

### TECHNICAL FIELD OF THE INVENTION

The present disclosure is related to an image processing method of a duplex printing device and is particularly related to a duplex printing device and an image offset correction method thereof.

### DESCRIPTION OF THE PRIOR ART

With regard to the duplex printing device of the prior art, please refer to FIG. 8. In order to raise productive efficiency, components would be standardized so that a paper feed cassette may accommodate paper with different widths (e.g., Letter or A4 paper), and in order to maintain the output image in the center of the paper with the smaller width (e.g., A4 size), the paper feed cassette has a mechanical design for size adjustments. As shown in FIG. 8, the aforementioned mechanical design has a switching toggle lever linkage structure 31 (including components such as a guide roller) which links and adjusts the inner paper input tray 30 of the duplex printing device so that the adapted paper width on the inner paper input tray 30 changes, but the manufacturing cost of the aforementioned mechanical design is high, and the aforementioned mechanical design is vulnerable and is difficult to maintain. If the duplex printing device does not have the aforementioned mechanical design, a front side (first side) image would be generated on the center of the paper with different widths by transfer printing, but there is a problem of deviation or truncation of information of a rear side (second side) image.

With regard to the inner structure of the duplex printing device of the prior art, when the duplex printing is performed on the paper, the duplex printing device has a first printing path and a second printing path, and the paper has been located on the center of a paper feed cassette, and the first side of the paper passes through an image processing device by the first printing path. And then, the paper flips by the path switching module to which the first printing path and the second printing path are cooperatively connected due to the duplex printing, and the flipped paper is inputted to the inner paper input tray 30 by the second printing path. When the paper passes through the inner paper input tray 30, the second side of the paper would be center based on the adjusted switching toggle lever linkage structure 31 and continues to pass through the image processing device by the second printing path. It should be noted that the position of the first printing path and the position of the second printing path on the image processing device overlap.

However, in the duplex printing device of the prior art, the manufacturing cost of the switching toggle lever linkage structure is high, and the switching toggle lever linkage structure is vulnerable and is difficult to maintain. If the durability of the duplex printing device needs should be raised, the switching toggle lever linkage structure is not used, but it would cause the second side to be unable to line up with the center position of the image processing device so that the outputted second side image is shifted. Thus, it is easy to create a problem that the transfer print information is close to the edge of the paper or is truncated.

Hence, the prior art indeed has a necessity to further provide a more improved solution.

### SUMMARY

In light of the aforementioned deficiencies of the prior art, the main object of the present disclosure is to provide a duplex printing device and an image offset correction method thereof which avoids the problem that the paper medium with different widths generate shifts or the transfer print information is truncated during the transfer printing.

In order to achieve the aforementioned object, a main technical solution adopted by the present disclosure is to facilitate the image offset correction method of the duplex printing device via a paper medium to pass through an image processing device by a first path and a second path respectively to include steps as follows: in the first path, obtaining the first side alignment image of the paper medium; in the second path, obtaining the second side deviation image of the paper medium; calculating position deviation information according to the first side alignment image and the second side deviation image; and adjusting the light sensing position of the image processing device based on the position deviation information.

By the aforementioned method, the duplex printing device calculates the position deviation information according to the first side alignment image (i.e., front side image) of the paper medium obtained in the first path and the second side deviation image (i.e., rear side image) of the paper medium obtained in the second path and adjusts the light sensing position of the image processing device on the second path based on the position deviation information. Thus, when the second side of the paper medium is printed, the duplex printing device may set the position of the transfer print information on the center of the second side of the paper medium with any size according to the adjusted light sensing position to achieve the effects of reducing the deviation or the truncation of the transfer print information.

In order to achieve the aforementioned object, another technical solution adopted by the present disclosure is to facilitate the duplex printing device to include a paper feed cassette, a first conveyor module, a second conveyor module, an image processing device and a processor. The paper feed cassette provides a paper medium to place. The first conveyor module is configured on a first path. The second conveyor module is configured on a second path, and the second path partially overlaps the first path, and the part of the second path overlapping the first path constitutes an overlapping path. The image processing device is disposed on the overlapping path. The processor is connected to the image processing device. The image processing device obtains a first side alignment image of the paper medium when the paper medium passes through the first path. The image processing device obtains a second side deviation image of the paper medium when the paper medium passes through the second path. The processor calculates position deviation information according to the first side alignment image and the second side deviation image and adjusts the light sensing position of the image processing device based on the position deviation information.

By the aforementioned configuration, the duplex printing device calculates the position deviation information according to the first side alignment image (i.e., front side image) of the paper medium obtained in the first path and the second side deviation image (i.e., rear side image) of the paper medium obtained in the second path and adjusts the light sensing position of the image processing device on the second path based on the position deviation information. Thus, when the second side of the paper medium is printed, the duplex printing device may set the position of the transfer print information on the center of the second side of the paper medium with any size according to the adjusted light sensing position to achieve the effects of reducing the deviation or the truncation of the transfer print information.

### BRIEF DESCRIPTION OF DRAWINGS

FIG. 1 is a block schematic diagram of a duplex printing device according to one embodiment of the present disclosure.

FIG. 2A is an application description diagram of a duplex printing device according to one embodiment of the present disclosure.

FIG. 2B is an application description diagram of a duplex printing device according to one embodiment of the present disclosure.

FIG. 3 is a schematic diagram of a first path and a second path of a duplex printing device according to one embodiment of the present disclosure.

FIG. 4 is a schematic diagram of a paper input tray of a duplex printing device according to one embodiment of the present disclosure.

FIG. 5 is a block schematic diagram of a duplex printing device according to another embodiment of the present disclosure.

FIG. 6 is the flowchart of the image offset correction method of the duplex printing device according to one embodiment of the present disclosure.

FIG. 7A is the flowchart of the image offset correction method of the duplex printing device according to another embodiment of the present disclosure.

FIG. 7B is the flowchart of the image offset correction method of the duplex printing device according to yet another embodiment of the present disclosure.

FIG. 8 is the top plan view diagram of the paper input tray of the second path of the duplex printing device of the prior art.

### DETAILED DESCRIPTION

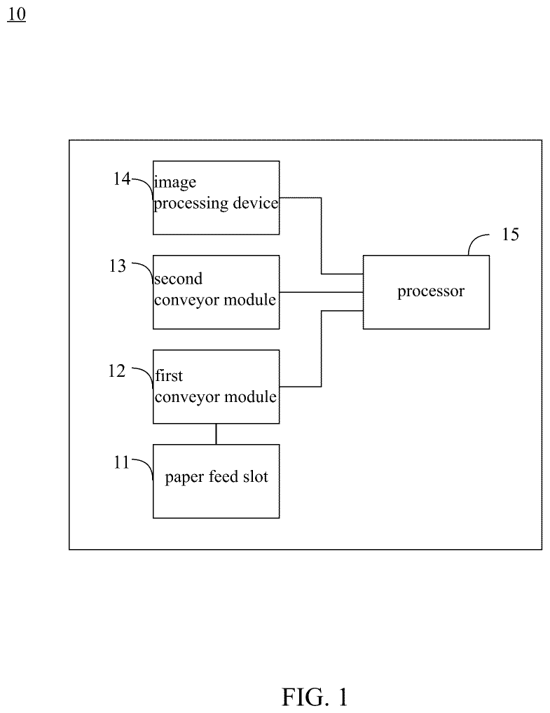

With regard to the duplex printing device 10 of the embodiment of the present disclosure, as shown in FIG. 1, the duplex printing device 10 includes a paper feed cassette 11, a first conveyor module 12, a second conveyor module 13, an image processing device 14 and a processor 15. The paper feed cassette 11 supports a paper medium. The first conveyor module 12 is configured on a first path, the second conveyor module 13 is configured on a second path, the second path partially overlaps the first path, and the part of the second path overlapping the first path constitutes an overlapping path. The image processing device 14 is disposed on the overlapping path, and the processor 15 is connected to the image processing device 14.

When the paper medium passes through the first path of the first conveyor module 12, the image processing device 14 obtains a first side alignment image (i.e., front side image) of the paper medium; when the paper medium passes through the second path of the second conveyor module 13, the image processing device 14 obtains a second side deviation image (i.e., rear side image) of the paper medium. Thereafter, the processor 15 calculates position deviation information according to the first side alignment image and the second side deviation image and adjusts the light sensing position of the image processing device 14 according to the position deviation information. Thus, the processor 15 of the duplex printing device 10 may set position of transfer print information on the center of the second side (i.e., rear side) of the paper medium with any size according to the software and the firmware control information of the adjusted light sensing position stored in a setting stage to avoid the problem the deviation (i.e., close to the edge of the paper) or the truncation of the transfer print information.

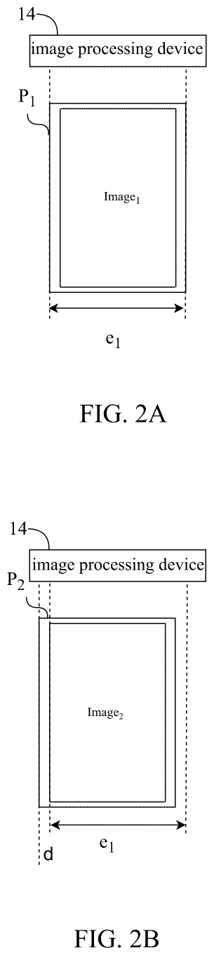

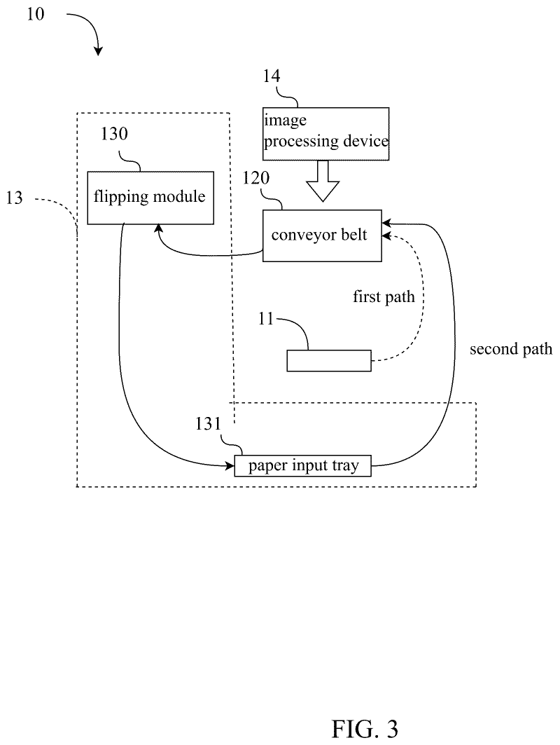

In order to describe the specific application mode of the present embodiment in details, please refer to FIG. 2A, FIG. 2B and FIG. 3, and the paper medium P is placed on the paper feed cassette 11 by centering. The first conveyor module 12 may include a conveyor belt 120, and the conveyor belt 120 is configured to convey the paper medium P on the overlapping path. After the image processing device 14 generates the first side alignment image Image₁ on the paper medium P according to imaging scope information e₁, the image processing device 14 obtains the first side alignment image Image₁ of the first side P₁, and the first side alignment image Image₁ obtained by the image processing device 14 serves as the foundation of the subsequent operation. Thereafter, the conveyor belt 120 conveys the paper medium P to the second conveyor module 13. In the present embodiment, the image processing device 14 may also obtain the image of the first side P₁ serving as the foundation of the subsequent operation.

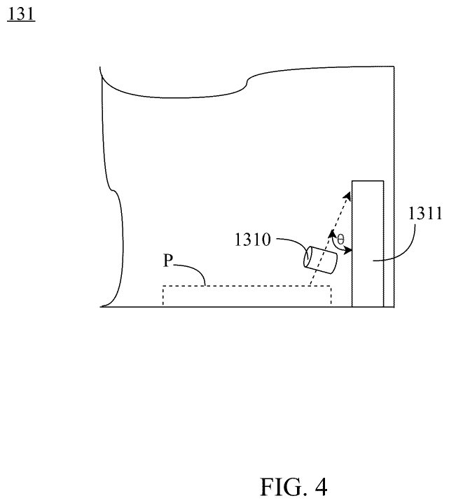

Please refer to FIG. 3 and FIG. 4. The second conveyor module 13 includes a flipping module 130 and a paper input tray 131. The flipping module 130 is connected to the conveyor belt 120 to receive the paper medium P from the conveyor belt 120, and flips the paper medium P when receiving the paper medium P. The paper input tray 131 is connected to the conveyor belt 120 and the flipping module 130 to receive the flipped paper medium P and is adapted to the paper medium with various sizes (e.g., Letter or A4 paper). In the present embodiment, there is an auxiliary guide roller 1310 pivotably disposed on the paper input tray 131, and the auxiliary guide roller 1310 is configured to guide the paper medium P to approach the resisting part 1311 of the paper input tray 131. In the present embodiment, the resisting part 1311 may consist of one side wall of the paper input tray 131, and the angle between the resisting part 1311 and the auxiliary guide roller 1310 is less than 90°. After the image processing device 14 generates the first side alignment image Image₁, the conveyor belt 120 would convey the paper medium P to the flipping module 130 to flip the paper medium P. After the paper medium P is flipped, the flipped paper medium P is conveyed to the paper input tray 131. And then, the auxiliary guide roller 1310 pivotably disposed on the paper input tray 131 would guide one side edge of the paper medium P to line up with the resisting part 1311 inside the paper input tray 131. Thereafter, the paper medium P would be conveyed to the conveyor belt 120.

Please refer to FIG. 2A, FIG. 2B and FIG. 3. In the present embodiment, when the paper medium P passes through the second path of the second conveyor module 13, the image processing device 14 generates the second side deviation image Image₂ on the second side P₂ of the paper medium P. As shown in FIG. 1, FIG. 2A and FIG. 2B, according to the first side alignment image Image₁ and the second side deviation image Image₂, the processor 15 calculates the position deviation information d between the first side alignment image Image₁ and the second side deviation image Image₂. Afterward, the processor 15 adjusts the light sensing position of the image processing device 14 on the second path according to the position deviation information d. In another embodiment, the processor 15 may also calculate the position deviation information d between the image of the first side P₁ and the image of the second side P₂. In the aforementioned calculation of the position deviation information d, the processor 15 may utilize the pixel subtraction to calculate and obtain the position deviation information d by, i.e., the pixel value of the first side alignment image Image₁ is subtracted from the pixel value of the second side deviation image Image₂ to obtain the position deviation information d. However, the difference calculation between the first side alignment image Images and the second side deviation image Image₂ may be implemented by using the well-known techniques in the prior art, and the aforementioned descriptions are examples for explanation instead of limiting the present disclosure.

In the present embodiment, as shown in FIG. 1 and FIG. 3, the duplex printing device of the present disclosure may consist of a duplex printer, and the paper feed cassette 11, the first conveyor module 12, the second conveyor module 13, and the flipping module 130 and the paper input tray 131 may consist of the mechanisms of the duplex printer. The light source module and the photosensitive drum of the duplex printer may be used to constitute the image processing device 14 and may be electrically connected to the processor 15, and the processor 15 may drive and control the light source module and the photosensitive drum. The processor 15 in the present embodiment may be a central processing unit (CPU) or a graphical processing unit (GPU).

In the present embodiment, the light source module may consist of a LED print head (LPH) or a laser scanning unit (LSU), wherein the LPH includes a LED array and is electrically connected to the processor 15, and the processor 15 transmits a control signal for light sensing scope to the LPH according to the position deviation information d, and therefore, the light sensing position of the image processing device 14 may change. In addition, the LSU may include a laser and be electrically connected to the processor 15, and the way of changing the light sensing position of the image processing device 14 of the LSU is the same as the way of changing the light sensing position of the image processing device 14 of the LPH.

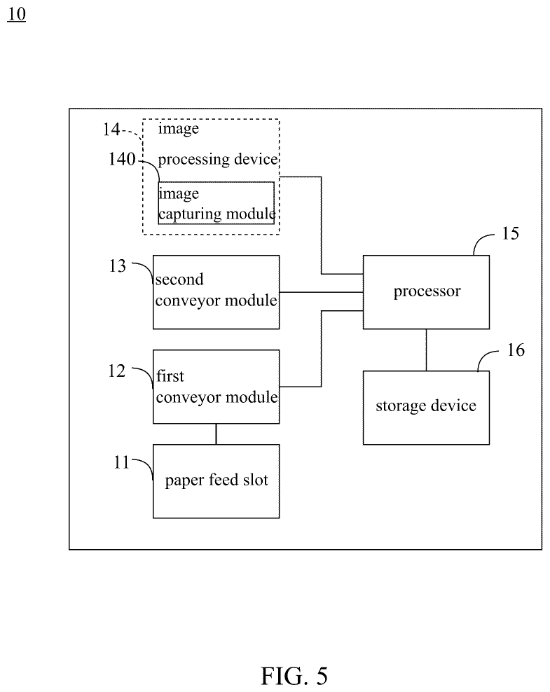

In the present embodiment, as shown in FIG. 2A, FIG. 2B and FIG. 5, the duplex printing device 10 further includes a storage device 16 connected to the processor 15, and the storage device 16 stores the imaging scope information e₁ and the position deviation information d. The storage device 16 may expand the amount of stored data, and may store more image information, and can also build different imaging scopes, deviation information, etc. The storage device 16 in the present embodiment may be a memory, a memory card, etc.

In the present embodiment, as shown in FIG. 2A, FIG. 2B and FIG. 5, the image processing device 14 further includes an image capturing module 140, and the image capturing module 140 is configured to capture the position of the first side alignment image Image₁ on the first side P1 and the position of the second side deviation image Image₂ on the second side P2 to provide the computable position deviation information d to the processor 15.

In order to explain how to calculate the position deviation information d by the processor 15, in the present embodiment, the processor 15 performs position subtraction according to the position of the first side alignment image Image₁ and the position of the second side deviation image Image₂ to generate the position deviation information d. Specifically, the processor 15 performs pixel subtraction according to the pixel value of the first side alignment image Image₁ and the pixel value of the second side deviation image Image₂ to generate the position deviation information d.

Hence, the position deviation information d is obtained by the foregoing paragraphs. When a user performs the duplex printing on the paper medium P, the duplex printing device 10 of the present disclosure regards the point of which distance is the position deviation information d from the first side alignment image Images of the paper medium P as the imaging initial point of the second side P2 during the imaging of the second side P2 of the paper medium P so that the imaging of the second side P2 may be center.

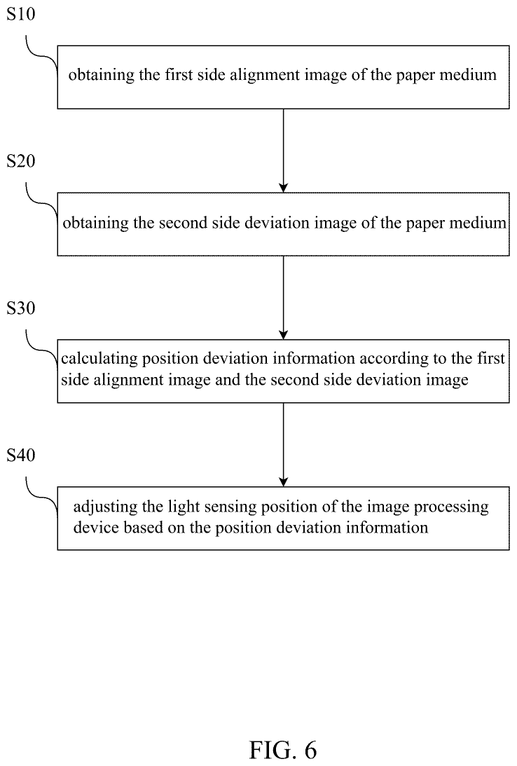

Based on the application mode of the above preferable embodiment of the present disclosure, the image offset correction method of the duplex printing device may be deduced. As shown in FIG. 6, the image offset correction method of the duplex printing device inducing the paper medium P to pass through the image processing device 14 by the first path and the second path includes performing the following steps by the processor 15:
in the first path, obtaining the first side alignment image Image₁ of the paper medium P (S10), wherein the image processing device 14 obtains the first side alignment image Image₁ when the paper medium P passes through the first path;
in the second path, obtaining the second side deviation image Image₂ of the paper medium P (S20), wherein the image processing device 14 obtains the second side deviation image Image₂ when the paper medium P passes through the second path;
calculating the position deviation information d according to the first side alignment image Image₁ and the second side deviation image Image₂ (S30); and
adjusting the light sensing position of the image processing device 14 according to the position deviation information d (S40).

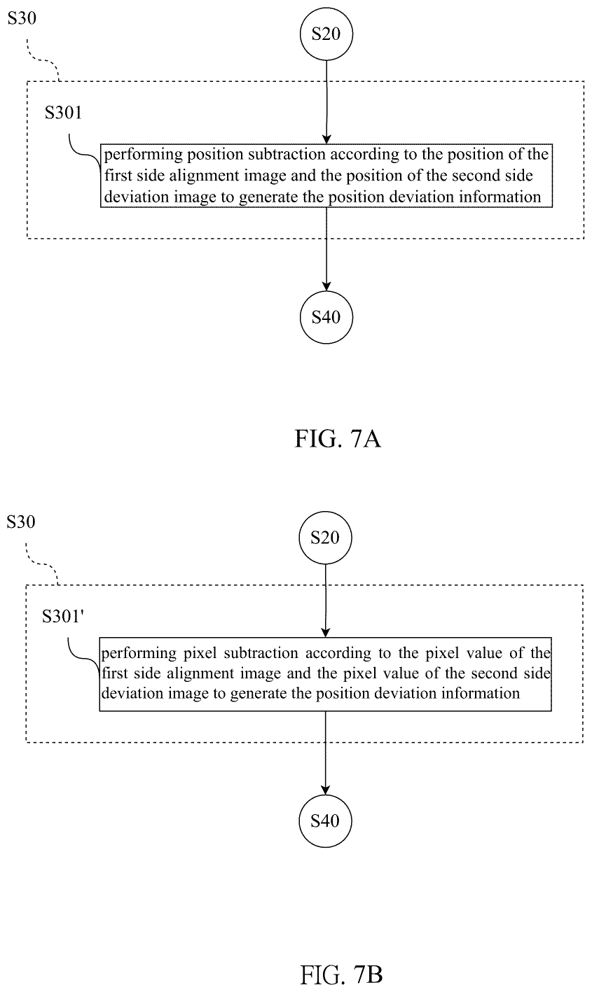

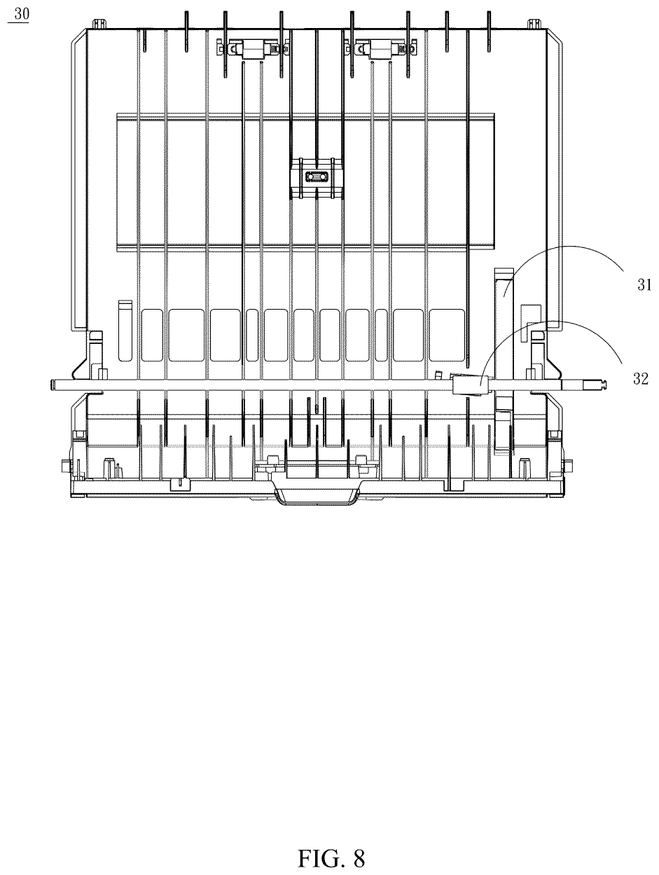

In this embodiment, as shown in FIG. 7A, calculating the position deviation information d according to the first side alignment image Image₁ and the second side deviation image Image₂ (S30) in the above method includes a sub-step as follows:
performing position subtraction according to the position of the first side alignment image Image₁ and the position of the second side deviation image Image₂ to generate the position deviation information d (S301); in the present embodiment, the calculation of the position subtraction may be based on the first coordinate position of the first side alignment image Image₁ and the second coordinate position of the second side deviation image Image₂, and the first coordinate position of the first side alignment image Image₁ is subtracted from the second coordinate position of the second side deviation image Image₂ to generate the position deviation information d.

In another embodiment, as shown in FIG. 7B, calculating the position deviation information d according to the first side alignment image Image₁ and the second side deviation image Image₂ (S30) in the above method includes a sub-step as follows:
performing pixel subtraction according to the pixel value of the first side alignment image Image₁ and the pixel value of the second side deviation image Image₂ to generate the position deviation information d (S301′).

In view of the above description, the duplex printing device 10 calculates the position deviation information d according to the first side alignment image Image₁ of the paper medium P obtained in the first path and the second side deviation image Image₂ of the paper medium P obtained in the second path and adjusts the light sensing position of the image processing device 14 according to the position deviation information d. Thus, during printing, the duplex printing device 10 may directly adjust the light sensing position of the paper medium P on the second path according to the position deviation information d so that the position of the transfer print information may be set on the center of the second side (i.e., rear side) of the paper medium P with any size. Hereby, the present disclosure can avoid the deviation or the truncation of the transfer print information.

What is claimed is:

1. An image offset correction method of a duplex printing device via a paper medium to pass through an image processing device by a first path and a second path respectively, and the image offset correction method of the duplex printing device comprising steps as follows:
in the first path, obtaining a first side alignment image of the paper medium;
in the second path, obtaining a second side deviation image of the paper medium;
calculating position deviation information according to the first side alignment image and the second side deviation image; and
adjusting a light sensing position of the image processing device according to the position deviation information.

2. The image offset correction method of the duplex printing device according to claim 1, wherein calculating position deviation information according to the first side alignment image and the second side deviation image comprises a sub-step as follows:
performing position subtraction according to a position of the first side alignment image and a position of the second side deviation image to generate the position deviation information.

3. The image offset correction method of the duplex printing device according to claim 1, wherein calculating position deviation information according to the first side alignment image and the second side deviation image comprises a sub-step as follows:
performing pixel subtraction according to a pixel value of the first side alignment image and a pixel value of the second side deviation image to generate the position deviation information.

4. A duplex printing device comprising:
a paper feed cassette providing a paper medium to place;
a first conveyor module configured on a first path;
a second conveyor module configured on a second path, wherein the second path partially overlaps the first path, and a part of the second path overlapping the first path constitutes an overlapping path;
an image processing device disposed on the overlapping path; and
a processor connected to the image processing device;
wherein the image processing device obtains a first side alignment image of the paper medium when the paper medium passes through the first path; the image processing device obtains a second side deviation image of the paper medium when the paper medium passes through the second path; the processor calculates position deviation information according to the first side alignment image and the second side deviation image, and adjusts a light sensing position of the image processing device according to the position deviation information.

5. The duplex printing device according to claim 4, wherein the first conveyor module comprises:
a conveyor belt configured to convey the paper medium on the overlapping path.

6. The duplex printing device according to claim 5, wherein the first conveyor module comprises:
a flipping module connected to the conveyor belt to receive the paper medium from the conveyor belt, wherein the flipping module flips the paper medium when receiving the paper medium; and
a paper input tray connected to the conveyor belt and the flipping module and receiving the flipped paper medium.

7. The duplex printing device according to claim 6, wherein the paper input tray further comprises:
an auxiliary guide roller pivotably disposed on the paper input tray; and
a resisting part disposed on the paper input tray at an angle less than 90° with the auxiliary guide roller;
wherein the auxiliary guide roller guides the paper medium to approach the resisting part.

8. The duplex printing device according to claim 4, wherein the duplex printing device further comprises:
a storage device connected to the processor and storing imaging scope information and the position deviation information.

9. The duplex printing device according to claim 4, wherein the duplex printing device further comprises:
an image capturing module configured to capture a position of the first side alignment image and a position of the second side deviation image.

10. The duplex printing device according to claim 4, wherein the processor performs position subtraction according to a position of the first side alignment image and a position of the second side deviation image to generate the position deviation information.

11. The duplex printing device according to claim 4, wherein the processor performs pixel subtraction according to a pixel value of the first side alignment image and a pixel value of the second side deviation image to generate the position deviation information.
